(19) United States
(12) Patent Application Publication
(10) Pub. No.: US 2007/0237561 A1
(43) Pub. Date: Oct. 11, 2007

(54) Methods and apparatuses for sensing a print area using a hand-held printer

(75) Inventors: Adam Jude Ahne, Lexington, KY (US); Mark Aaron Neal, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International Inc.

(21) Appl. No.: 11/402,147

(22) Filed: Apr. 11, 2006

(51) Int. Cl. B41J 3/36

(52) U.S. Cl. 400/88

(57) ABSTRACT

A hand-held printer includes two or more tracking devices, such as optical sensors, located adjacent a print head. The two or more tracking devices permit the identification of a printing surface underneath at least one of the tracking devices, such that the movement of the hand-held printer along or near an edge of the printing surface can be identified even where at least one tracking device falls off of the printing surface.

### FIELD OF THE INVENTION

The present invention relates generally to handheld printers, and more particularly, to systems, methods and apparatuses for identifying a print area of a hand-held printer.

### BACKGROUND OF THE INVENTION

Portable computer printers are well known in the prior art and include dot-matrix printers, piezo-electric ink jet printers, laser printers and thermal ink jet printers. When using handheld printers the printing surface is not fed through printer, but rather the handheld printer is placed on a printing surface, such as paper.

It will be appreciated that conventional hand-held printers typically include one sensor located at a distance removed from the printer head, such as above the printer head, to identify the location of the printer with respect to a printing surface. In operation, the handheld printer is aligned with a desired printing position on the printing surface using one or more marks on the printer. Thereafter, the user depresses a print button and sweeps the printer horizontally until the printer head passes over the target position where printing begins.

This configuration of the sensor and print head in conventional designs does not allow the user to print near an edge a printing surface because the sensor will fall off the printing surface and fail to identify that the printer is positioned on the printing surface. Therefore, the user must place the printing surface on a flat media that has sufficient texture for the sensor to use for tracking. However, oftentimes the printing surface is placed on flat media that does not permit the effective operation of the sensor. What is needed are methods and apparatuses that enables a user to easily print near the edges of a printing surface (e.g., near the top of a page).

### BRIEF SUMMARY OF THE INVENTION

Methods and apparatuses of the present invention utilize two or more tracking devices (or position sensors) located adjacent a print head of a hand-held printer. The two or more sensors allow at least one to be redundant and permit the identification of a printing surface underneath at least one sensor such that the movement of the hand-held printer along or near an edge of the printing surface can be identified even where at least one sensor falls off of the printing surface.

According to an embodiment of the invention, there is disclosed a hand-held printer. The hand-held printer includes at least one print head operable to eject ink from the hand-held printer onto a printing surface, a first tracking device disposed substantially adjacent to a first side of the at least one print head, and a second tracking device disposed substantially adjacent to a second side of the at least one print head. During use of the hand-held printer at least one of the first tracking device and the second tracking device identifies the relative movement of the at least one print head with respect to the printing surface.

In an embodiment of the invention, at least one of the first tracking device and the second tracking device measure lateral displacement of the at least one print head with respect to the printing surface. In some embodiments, the printer can include a third tracking device disposed substantially adjacent to a third side of the at least one print head. In additional embodiments, at least one of the first tracking device and the second tracking device measure displacement or rotation of the at least one print head with respect to the printing surface.

The hand-held printer can also include an application specific integrated circuit (ASIC) operable to receive image information signals from at least one of the first tracking device and the second tracking device. The ASIC can determine the relative signal strength of the image information signals received from the first tracking device and the second tracking device. The can also or alternatively determine the relative movement of the at least one print head with respect to the printing surface using the image information signals received from at least one of the first tracking device and the second tracking device. In an embodiment, each of the first tracking device and the second tracking device can include optical sensors.

According to another embodiment of the invention, there is disclosed a method of identifying movement of a hand-held printer. The method includes receiving a first signal strength from a first tracking device of the hand-held printer, receiving a second signal strength from a second tracking device of the hand-held printer, comparing the first signal strength to the second signal strength to identify the stronger signal of the two signal strengths, and identifying a movement of the hand-held printer based on image information provided by the tracking device associated with the stronger signal of the two signal strengths.

According to one embodiment of the invention, the comparing step is performed by an application specific integrated circuit. In some embodiments, the method includes iteratively repeating the receiving and comparing steps. In additional embodiments, each of the first tracking device and the second tracking device comprise optical sensors.

The method may also include disposing the first tracking device substantially adjacent to a first side of a print head, and disposing the second tracking device substantially adjacent to a second side of the print head. A third tracking device can be disposed substantially adjacent to a third side of a print head. In some embodiments, identifying movement of the hand-held printer includes identifying a lateral displacement or a rotation of the hand-held printer with respect to an earlier location of the hand-held printer. In some embodiments, the method can include the steps of periodically polling the first tracking device and/or second tracking device to request the first signal strength and/or second signal strength, respectively.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a perspective view of a hand-held printer, according to an illustrative embodiment of the present invention.

FIG. 2 shows a top view of a hand-held printer, according to an illustrative embodiment of the present invention.

FIG. 3 shows the bottom view of a hand-held printer, according to an illustrative embodiment of the present invention.

FIG. 4 shows the placement of a hand-held printer near the corner of a printing surface, according to an illustrative embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

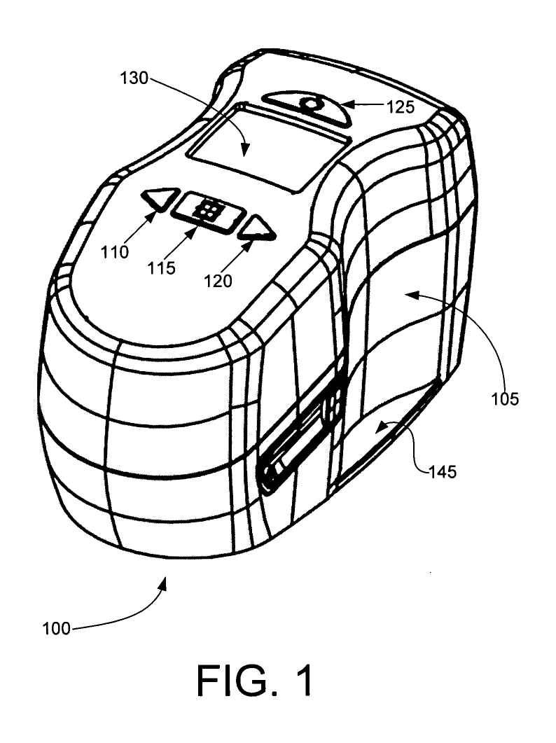

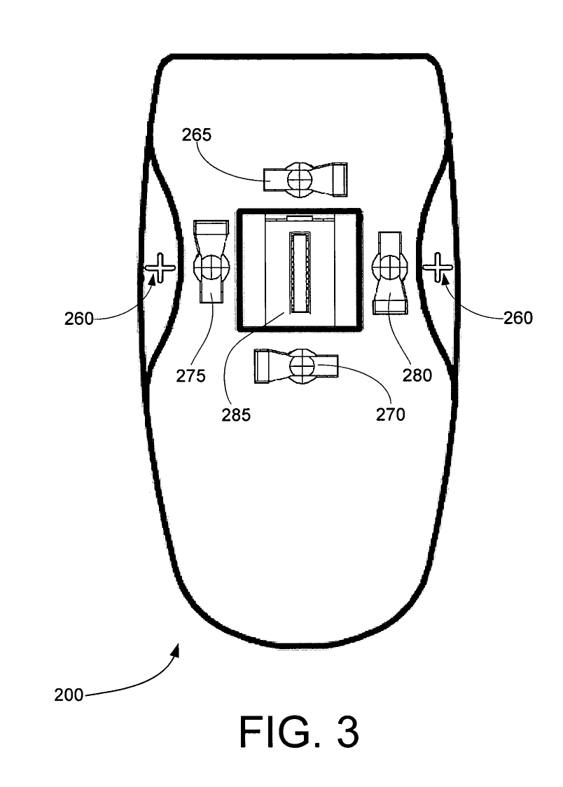

FIG. 1 shows a perspective view of a hand-held printer 100, according to an embodiment of the present invention. The hand-held printer 100 generally includes a housing 105 for enclosing printer components, a display screen 130, such as an LCD screen, and one or more buttons 110, 115, 120, 125 for controlling the operation of hand-held printer 100. To print the hand-held printer 100 also includes a printer head (not illustrated) that emits a marking substance, such as ink, onto a printing surface. Also included within the hand-held printer 100 are two or more internal tracking devices (not illustrated) to identify the location of the hand-held printer 100. The two or more tracking devices may include an optical mouse tracking device, as is described below with respect to FIG. 3, which identifies the current location of the hand-held printer 100 with reference to an earlier location of the hand-held printer 100.

In an embodiment, the one or more buttons 110, 115, 120, 125 are operative to enable a user to select and control one or more operations or functions of the hand-held printer 100. For instance, the buttons 110, 115, 120, 125 permit a user to select an image for printing, to print using the hand-held printer 100, to measure the print area of a printing surface, and the like. In some embodiments, the one or more buttons 110, 115, 120, 125 may represent ‘soft’ buttons whose associated functions are displayed on the display 130. In some embodiments, the one or more buttons 110, 115, 120, 125 may be used to highlight and select functions displayed on the display 130. Although illustrated on a top side of the hand-held printer 100, it will be appreciated that the one or more buttons 110, 115, 120, 125 may be positioned anywhere on the housing 105 of the hand-held printer 100.

A user may initiate printing through the issuance of a command to the handheld printer 110. Such a command may come from the pressing of one or more buttons 110, 115, 120, 125, which may trigger the print head to begin printing an image. In alternate embodiments, print commands may come by way of voice commands or optical impulses. The handheld printer 100 may receive image data for printing from a number of sources. For instance, the handheld printer 100 may receive image data from a computer via a cable or wireless connection, such as via a USB cable or via Bluetooth®. The image data will be stored within a memory in the hand-held printer 100 for use in printing. According to another illustrative embodiment, a memory card containing image data, for instance, in an image file, may be inserted in to the handheld printer 100 and act as the local memory of the printer.

As illustrated in FIG. 1, the handheld printer 100 includes a display screen 130. The display screen 130 may display a representation of the amount of the currently printing image that has been printed at any given point in time. In some embodiments, the user can view the image to be printed on the LCD screen, or may view a file name associated with the image. The display screen 130 can also alert the user that an image has been completely printed by the hand-held printer 100.

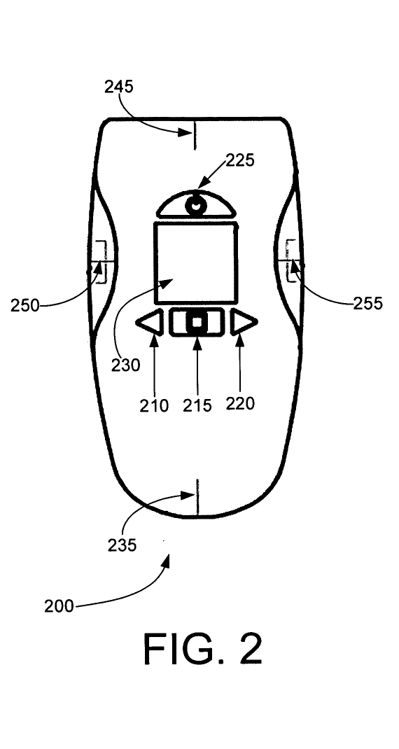

FIG. 2 shows a top view of a handheld printer 200, according to an illustrative embodiment of the present invention. In some embodiments, the hand-held printer 200 includes a display 230 and one or more buttons 210, 215, 220, 225 that operate in a similar manner, respectively, as the display 130 and one or more buttons 110, 115, 120, 125 described above with respect to FIG. 1. As shown in FIG. 2, the hand-held printer 200 also includes left and right alignment marks 250, 255, and upper and lower alignment marks 245, 235. The left and right alignment marks 250, 255 each include a horizontally disposed line, while the upper and lower alignment marks 245, 235 each include a vertically disposed line. In some embodiments, each of the four alignment marks 250, 255, 245, 235 may be disposed on a flat surface extending from one or more indentations in the housing of the hand-held printer 200. For instance, the left and right alignment marks 250, 255 may be disposed on flat surfaces on each side of the hand-held printer 200 similar to the flat surface 145 shown on the hand-held printer 100 of FIG. 1.

Next, FIG. 3 shows an underside of the hand-held printer 200 of FIG. 2, according to an embodiment of the present invention. The underside of the hand-held printer 200 includes a print head 285 that emits a marking substance, such as ink, onto a printing surface to print an image. The underside also includes tracking devices 265, 270, 275, 280 that are operable to identify the location of the hand-held printer 200 on a printing surface. As described below, when at least one of the sensors 265, 270, 275, 280 are located above a surface (such as a printing surface) that permits at least one sensors to detect surface variations, the tracking device can identify the distance and direction of travel of the hand-held printer 200.

In some embodiments, the tracking devices 265, 270, 275, 280 can each include an optical sensor, such as optical mouse sensors. Optical sensors, as are well known in the art, permit the hand-held printer 200 to track the position of the hand-held printer 200 relative to the surface of a printing surface during a printing process. Each optical sensor typically includes an array of opto-electronic elements to capture images of the print surface at fixed time intervals. Optical sensors provide image information to an ASIC, processor, or the like that processes image information received from the sensor to detect slight pattern variations on the print surface, such as paper fibers or illumination pattern formed by highly reflective surface features, and shadowed areas between raised surface features. These features are used as references for determining the position and the relative movement of the hand-held printer 200. Because optical sensors are well known in the art, as are the methods for processing image information retrieved there from to determine the position and relative movement of the printer 200, those elements will not be described in greater detail herein.

As shown in FIG. 3, the tracking devices 265, 270, 275, 280 are located on four sides of the print head 285. The position of the four tracking devices 265, 270, 275, 280 permits operation of the printer 200 even where three of the tracking devices fall off of a printing surface, are inoperable, or return insufficient image information to reliably determine the direction or distance of travel of the hand-held printer 200. Unlike conventional devices, which may be unable to print near the edge of a page as a result of the devices' single sensor falling off the page, the present invention can ensure that at least one sensor is directly opposite a printing surface that will receive ink from a print head 285.

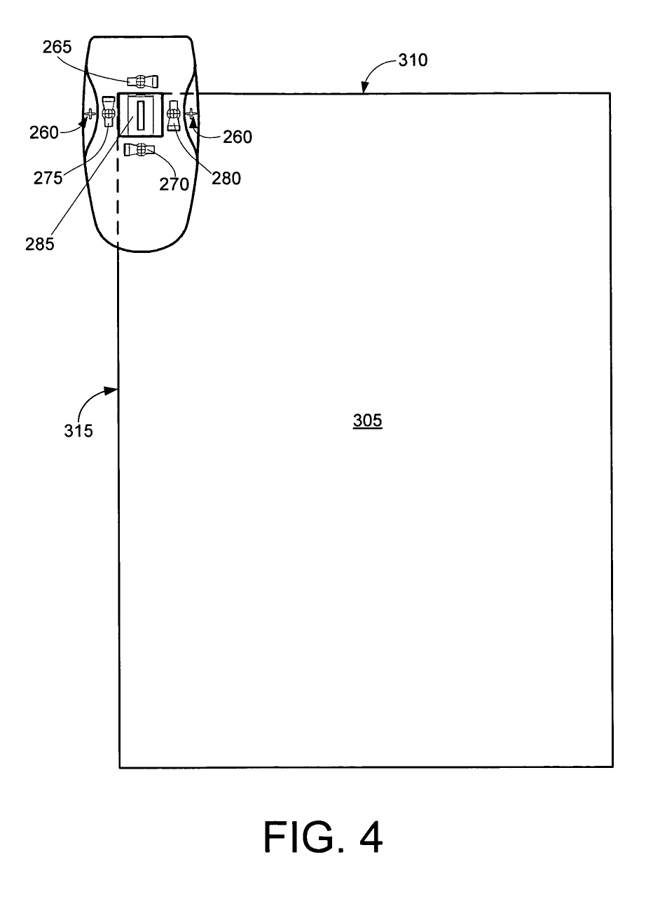

FIG. 4 shows an illustrated the placement of a hand-held printer 200 near the edges of a printing surface 305, such as a piece of paper, according to an illustrative embodiment of the present invention. When the hand-held printer 200 is placed near the upper left corner of the printing surface 305, i.e., near the intersection of the top edge 310 and left edge 315 of the printing surface 305, two of the tracking devices 270, 280 are directly opposite the paper, while two 265, 275 fall off of the surface of the printing surface 305 and may be inoperable. Thus, when the user drags the hand-held printer 200 across the printing surface 305, such as directly to the right or down, the printer 200 can track the displacement and speed of the printer 200 and continuously update the printer driver within the printer to continue printing on the surface detected by the operable tracking devices 270, 280.

For instance, in a coordinate system where the first number in a coordinate pair identifies the horizontal location of the printer 200 and the second number identifies the vertical location of the printer 200, if the left edge is set to coordinates (0,0), the right edge may be at (X,Y) due to horizontal (and possibly inadvertent) vertical displacement when the user drags the hand-held printer 200 across the printing surface 305. In this illustrative example, the printer may presume that the top left corner of the printing surface 305 is at coordinate (0,B), the top right corner is at coordinate (X,B), the lower left corner is at coordinate (0,−D), and the lower right corner is at coordinate (X,−D). As the printer 200 traverses the printing surface 305, the printer can continuously compute the location of the printer 200 on the paper using the coordinate system. As the printer moves across the surface, the image is placed onto the media. Because the location of the printer is known based on the internal tracking device, the printer is operable to print the necessary elements image at each location in which the printer is moved.

In some embodiments, the hand-held printer 200 can include a digital ASIC that decides which of the tracking devices to use by determining which tracking device outputs the most edges, i.e., is sensing the most displacement in the movement of the printer 200. This determination can be performed at the start of a swath before the printer has traveled to the targeted position, or the digital ASIC can periodically poll the sensors during the swath to see which one returns the strongest image information signal. The comparison of image information, including signal strength, received from the respective tracking devices may be effected by one or more algorithms stored within a memory of the hand-held printer 200, which may be executed by the aid of a processor or like computing device to effect the processes described herein. An ASIC (or two or more such devices) may also execute the processes described herein.

It should be appreciated that although the present invention is described with respect to an illustrative hand-held printer having four sensors, with one on each respective side of a print head, it should be appreciated that the present invention may be implemented with fewer sensors and/or sensors located on two or more sides of a print head. For instance, hand-held printers of the present invention may be implemented with tracking devices on opposite sides of a print head, or on three sides of a print head. In some embodiments, two sensors may be used to monitor displacement in the X,Y direction while another sensor may measure rotation of the printer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hand-held printer, comprising:
at least one print head, wherein the at least one print head is operable to eject ink from the hand-held printer onto a printing surface;
a first tracking device, disposed substantially adjacent to a first side of the at least one print head; and
a second tracking device, disposed substantially adjacent to a second side of the at least one print head,
wherein during at least one point in a print operation only one of the first tracking device and the second tracking device identifies the relative movement of the at least one print head with respect to the printing surface.

2. The hand-held print of claim 1, wherein at least one of the first tracking device and the second tracking device measure lateral displacement of the at least one print head with respect to the printing surface.

3. The hand-held printer of claim 1, further comprising a third tracking device, wherein the third tracking device is disposed substantially adjacent to a third side of the at least one print head.

4. The hand-held print of claim 1, wherein at least one of the first tracking device and the second tracking device measure rotation of the at least one print head with respect to the printing surface.

5. The hand-held printer of claim 1, further comprising an application specific integrated circuit (ASIC) operable to receive image information signals from at least one of the first tracking device and the second tracking device.

6. The hand-held printer of claim 5, wherein the ASIC is operable to determine the relative signal strength of the image information signals received from the first tracking device and the second tracking device.

7. The hand-held printer of claim 5, wherein the ASIC is operable to determine the relative movement of the at least one print head with respect to the printing surface using the image information signals received from at least one of the first tracking device and the second tracking device.

8. The hand-held printer of claim 1, wherein each of the first tracking device and the second tracking device comprise optical sensors.

9. A method of identifying movement of a hand-held printer, comprising:
receiving a first signal strength from a first tracking device of the hand-held printer;
receiving a second signal strength from a second tracking device of the hand-held printer;
comparing the first signal strength to the second signal strength to identify the stronger signal of the two signal strengths; and
identifying a movement of the hand-held printer based on image information provided by the tracking device associated with the stronger signal of the two signal strengths.

10. The method of claim 9, wherein the comparing step is performed by an application specific integrated circuit.

11. The method of claim 9, further comprising iteratively repeating the receiving and comparing steps.

12. The method of claim 9, wherein each of the first tracking device and the second tracking device comprise optical sensors.

13. The method of claim 9, further comprising:
disposing the first tracking device substantially adjacent to a first side of a print head; and
disposing the second tracking device substantially adjacent to a second side of the print head.

14. The method of claim 13, further comprising:
disposing a third tracking device substantially adjacent to a third side of a print head.

15. The method of claim 9, wherein identifying movement of the hand-held printer comprises identifying a lateral displacement of the hand-held printer with respect to an earlier location of the hand-held printer.

16. The method of claim 9, wherein identifying movement of the hand-held printer comprises identifying a rotation of the hand-held printer with respect to an earlier location of the hand-held printer.

17. The method of claim 9, further comprising the step of periodically polling the first tracking device to request the first signal strength.

18. The method of claim 17, further comprising the step of periodically polling the first tracking device to request the first signal strength.
